(19) United States
(12) Patent Application Publication
(10) Pub. No.: US 2005/0251473 A1
(43) Pub. Date: Nov. 10, 2005

(54) Methods of exchanging articles of commerce

(76) Inventor: Mario Viviani, Grosse Pointe Woods, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/842,159

(22) Filed: May 10, 2004

(51) Int. Cl. G06F 17/60

(52) U.S. Cl. 705/39

(57) ABSTRACT

A system for transaction verification includes a buyer remote from the seller and an escrow agent receiving the funds from the buyer, to be released to the seller upon a condition precedent. A goods verification agent verifies the good condition to a predetermined criterion to provide the condition precedent.

### FIELD OF INVENTION

The present invention relates to the field of electronic commerce implemented in a distributed network environment like the Internet or World Wide Web. Specifically, the invention relates to a method of online buying and selling of goods that safeguards the interests of both the seller and buyer, as well as reduces opportunities for Internet-related fraud.

### BACKGROUND OF THE INVENTION

The proliferation of Internet-based commerce has also ushered in a rash of fraudulent practices. Although statistics show that most Internet-based fraud is seen from online auction users, this problem is bound to explode as commercial transactions between general merchandisers and their buyers rapidly increase into the next generation. Part of this problem stems from the fact that sellers and buyers on the Internet are remote from each other, and often separated by countries and continents. Parties to these transactions may also come from societies and cultures with different ethical and commercial standards or practices.

A typical prior art online Internet-based trading system is eBay. eBay offers a global trading platform where various goods can be traded. For a seller, eBay is a virtual store where it can offer as few or as many goods for sale in limitless volumes by simply offering a description or image of the good. For a buyer, it is a virtual store where it can shop for and buy any good so long as the description or published image of the good is the object of the buyer's desire. In a typical scenario, a seller signs up to sell on eBay by first registering, and optionally choosing to use eBay's PayPal service for accepting credit card or electronic payment from a buyer. Next, the seller creates a listing for the item for sale describing the specifics of the item and including pictures where available. The seller then submits the item for listing on eBay. The buyer either bids for the item for sale or offers to buy it instantly. Once a buyer is found, the seller either communicates directly with the buyer or optionally through eBay's Checkout service subscription, and arrangements for payment and shipping are finalized. Once the seller receives payment from the buyer, either through PayPal service or otherwise as arranged between the parties, the seller is then obligated to ship the good for delivery to the buyer.

To the buyer, eBay offers advice on how to transact online commerce with measured risk. It also offers partial reimbursement (up to $200 for standard transactions and up to $500 for buyers employing the services of PayPal) for losses resulting from non-delivery or misrepresentation. To the seller, eBay offers PayPal as a way to ensure payment by a buyer and optionally provides the opportunity to limit the risk of chargeback in the event of dispute with or fraud by a buyer. Although these offerings from eBay help the parties limit their respective risks, it is evident that the buyer still bears the heavier risk burden because it must first advance payment before shipment of the good by the seller. To better balance this risk between the parties, especially when the transaction involves large value items, other online sales services have evolved.

A representative prior art system for balancing risk is escrow-based online sales services. Under this scenario, the seller describes the goods for sale, the condition of the goods, and maybe the terms of the offer. Next, the buyer expresses interest in the goods. Then, the seller and buyer agree to the value to be exchanged, such as price, as well as other terms. The buyer deposits the value with a third-party escrow agent. Once the seller gets verification of the deposit by the buyer, the seller proceeds with shipment of the goods to the buyer. The buyer receives the goods and inspects them for conformance. The buyer then notifies the third party of acceptance or rejection of the goods. If the goods were deemed acceptable, the buyer keeps the goods and the third party remits escrowed funds or ships the article of the trade to the seller. Otherwise, if the buyer deemed the goods unacceptable, they are shipped back to the seller and the third party remits escrowed funds or ships the article of trade back to the buyer.

Such solutions as the above help reduce the risk of conflict between a seller and buyer by the insertion of an objective third party that attempts to verify that a quid quo pro exchange occurs. Because the primary function of these electronic escrow services is to hold funds until goods are verified, they also increase the possibility of performance on the agreement, especially by the buyer.

In spite of the prior art efforts, some problems persist. There is no objective verification that the actual terms of the agreement between the parties are being adhered to by either party. There is also no opportunity to validate the veracity of either party's claim on the terms of the sale agreement. Lastly, the acceptance/rejection decision is left strictly at the discretion of the buyer, possibly increasing the overall cost of the transaction.

The prior art also teaches of an auction system and method for trading heavy equipment items in a networked environment, which includes a third party that examines the item for auction and provides an objective report on the condition of the equipment. This prior art teaches of a method that facilitates the participation of sellers and buyers in auction trade from remote locations. In this scenario, a seller delivers the equipment to be auctioned to the auction site. Prior to the date of the auction, a third party provides the quality control function of inspection of the equipment, and produces an independent, impartial assessment of the equipment. To reduce the possibility of fraud, the credit-worthiness of bidders is first verified before they are allowed to participate in the auction. Next, bidders are allowed to review the report from the third party, with the opportunity to utilize the report as a basis of their bid for the equipment. Bidders are then allowed to bid from remote locations through the network and across the world. At the conclusion of the auction, bidders are notified of the success or failure of their bids.

One advantage of the above prior art is that it provides necessary quality control facility for remote bidders who would not have access to the equipment they are bidding on. By relying on the bidders' credit-worthiness information, it also eliminates the need to hold funds in escrow until the bidder is satisfied with the subject of the bid and thus lowers the overall transaction cost of the auctioned item. By making it unnecessary to attend the auction and individually examine the item to be auctioned, this approach reduces the overall cost of the auction process. Finally, because it offers the opportunity for remote bidders from across the world to participate in the bidding process, it expands the market for heavy equipment merchandise.

However, this process has met with limited acceptance in other areas of commerce owing to the exclusive reliance on the expertise of third-party inspectors and their subjective judgment of the conditions of an article of commerce. The merchandise inspection report may not address or may omit a critical inspection item or acceptance criterion that a particular buyer considers a must-have. Therefore, in the typical general merchandise selling and buying online environment, opportunities for fraud and/or confusion abound.

Thus, there exists a need for a third-party system that assists the buyer and the seller with the verification of the terms of exchange of their article of commerce by introducing a higher level of precision in the execution of the agreement. Such a system would not only ensure that the payment is secured for the seller, but also that there is shipment and delivery of the article of commerce to the buyer. The system would also ensure optimal protection of privacy and anonymity for the parties to the transaction. It would also ensure the goods are what they purport to be and meet any other conditions set by the buyer for acceptance before they are shipped.

### SUMMARY OF THE INVENTION

The present invention is a method of reducing fraud in electronic commercial transactions between a buyer and a seller for the purchase of goods (or services), and a computer system implementing the method in an online networked environment such as the Internet or World Wide Web.

Advantageously, the system of the present invention involves a seller of a good and a buyer electronically connected to the seller, a third-party escrow agent to hold funds until a condition precedent is met, a third-party goods verification agent to provide the condition precedent according to a predetermined acceptance criterion which acceptance criterion may be determined by methods illustratively including using an x-ray device, radiofrequency identification tag, ultrasonic images, and an expert relative to the good that can advise the goods verification agent on the authenticity of the good. In the preferred embodiment of the present invention, a seller of a good and a buyer electronically connected to the seller agree on terms and conditions of sale including condition precedent to release of funds to the seller and predetermined criterion for acceptance of goods by the buyer. Upon agreement between the seller and buyer, funds are deposited with an escrow agent and the goods are shipped to a goods verification agent. The goods verification agent verifies the good relative to the predetermined condition to provide the escrow agent with the condition precedent.

In another embodiment, the present invention discloses a process for verifying goods in an online buyer-seller transaction. The process includes the steps of forwarding a payment for a good from a buyer to an escrow agent; notifying a seller that the escrow agent has received the funds from the buyer; shipping the good to a goods verification agent from the seller; verifying that the good satisfies a transaction criterion; notifying the escrow agent whether the good satisfied the criterion; forwarding the good to the buyer upon the criterion being satisfied; and remitting escrowed funds to the seller.

The present system and process offer many advantages over conventional systems. Because independent third parties rely on the specific agreement between the seller and the buyer before authorizing final consummation of the deal, the present invention helps to minimize the possibility of fraud in the execution of the agreement as well as help reduce the cost of these Internet-based transactions.

### BRIEF DESCRIPTION OF THE DRAWING

FIG. 1 is a system for reducing fraud in commercial transactions where the condition of acceptance has been met;

FIG. 2 is a system for reducing fraud in commercial transactions where the condition of acceptance has not been met;

FIG. 3 is a depiction of the process for reducing fraud in commercial transactions by scrutinizing goods in an online buyer-seller arrangement; and

FIG. 4 is another depiction of a series of interrelated processes to support the reduction of fraud in commercial transactions by scrutinizing goods in buyer-seller arrangements.

### DETAILED DESCRIPTION OF THE INVENTION

The present invention is a system and a process for reducing fraud in commercial transactions between a buyer and a seller electronically connected to one another for the sale and purchase of goods (or services). This invention especially lends itself to implementation in facilitation of electronic commerce like that conducted over the Internet or the World Wide Web, or any other integrated environment.

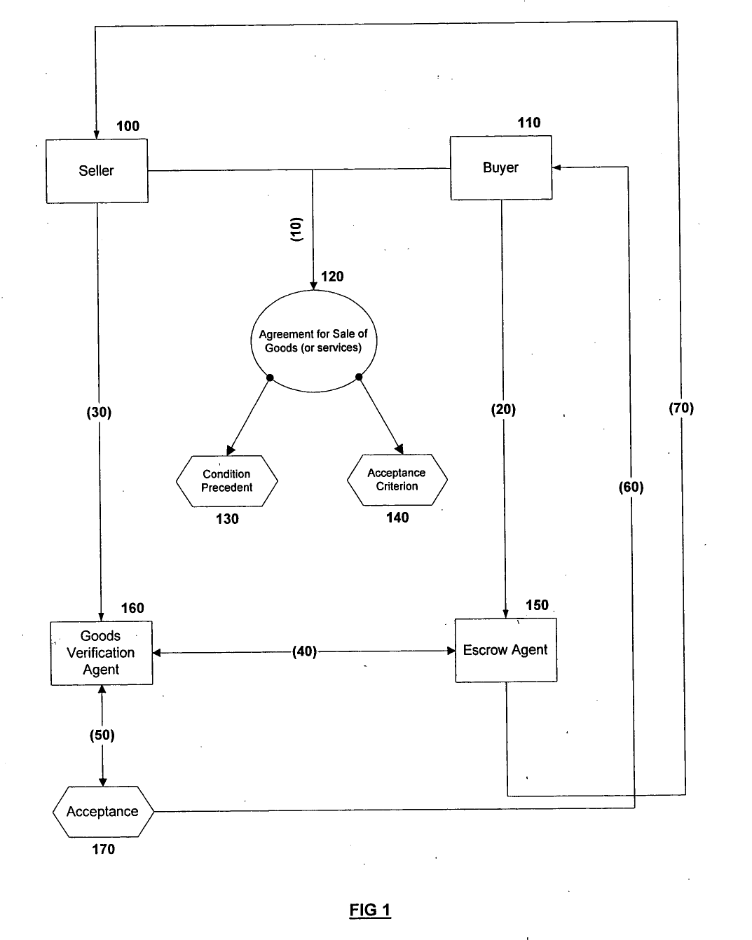

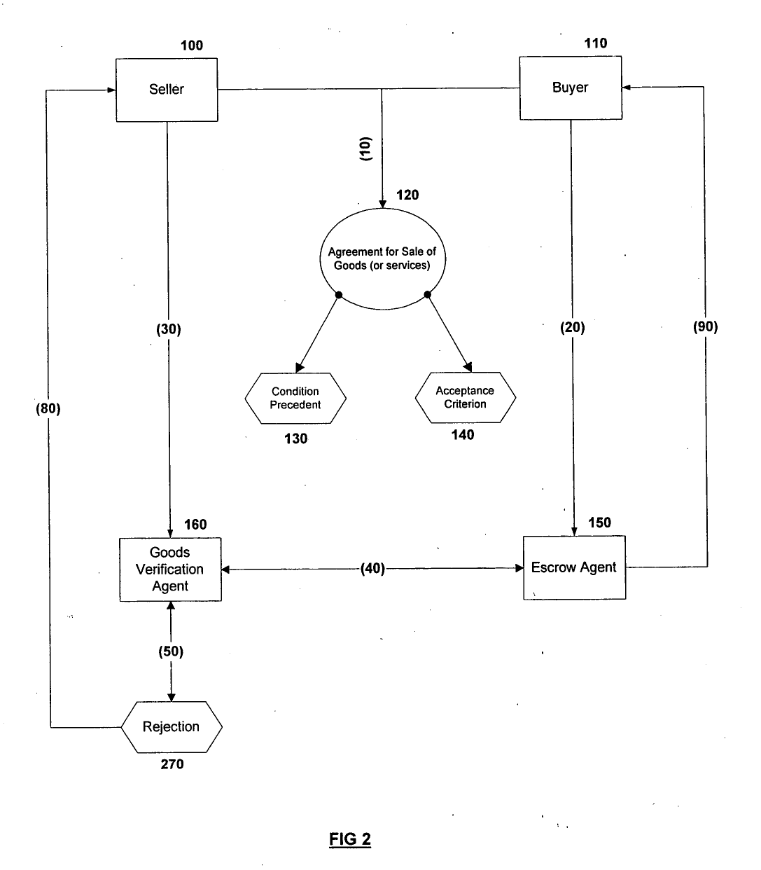

The present invention teaches of a system for conducting commercial transactions between parties that are electronically connected to each other in an online trading environment. Such a system is depicted in FIG. 1 and FIG. 2. The seller 100 has a good for sale and the buyer 110 is interested in purchasing the good. The seller and the buyer enter into agreement 120 for sale and purchase of the good for valuable consideration like cash. The system could be configured such that in determining a selling price, the seller adds a reasonable estimate for normal shipping and handling costs, and optionally offers the buyer, at the buyer's own added expense, the opportunity to enhance the shipping and handling service using a transportation calculator system. It is the totality of these costs that make up the price term of the agreement. Another term of the agreement is a condition precedent 130 to advancing payment to the seller. Another term of the agreement is an acceptance criterion 140 against which the good would be verified. The acceptance criterion may either be chosen from a predetermined list or specially negotiated between the buyer and the seller. Once the agreement is consummated 10, the buyer sends payment 20 to a third-party escrow agent 150 who holds the payment in escrow until notified that the acceptance criterion has been met. Upon receipt of payment from the buyer, the third-party escrow agent notifies the seller that it is in receipt of payment from the buyer. The seller subsequently delivers 30 the good to a third-party goods verification agent 160 who will verify the good relative to the acceptance criterion to provide the condition precedent. The good verification agent could be a package delivery company illustratively including USPS, UPS, FedEx, or the like, while the escrow agent could be an online brokerage agency illustratively including PayPal, Escrow.com, or the like.

The pertinent terms (such as price, acceptance criterion and condition precedent to payment of the seller) of the agreement are communicated by the seller and/or the buyer to both the third-party escrow agent and the third-party goods verification agent respectively. Because the buyer and seller are trading in the online trading environment, the communication to the escrow agent and goods verification agent may be accomplished through an integrated networked online application system like the Internet or World Wide Web. In a telephonic or mail communication between a buyer and seller, these modes are appreciated to also be amenable to goods verification according to the present invention. The system could be configured such that, in setting the agreement, the buyer is permitted to select from a list of predetermined acceptance criteria or to specify a customized level of verification as the acceptance criterion. Each criterion on the list carries with it an independent cost, depending on the complexity of verification needed. The customized or negotiated acceptance criterion will be assessed a customized or negotiated cost. The cost of the escrow agent could be shared by the seller and the buyer, or included in the selling price of the good. The cost of the goods verification agent could also be implemented such that the buyer pays a higher fee depending on the level of scrutiny of the product it requests.

Once in receipt of the good, the goods verification agent examines the good relative to the acceptance criterion. Depending on the acceptance selected by the buyer, the examination may be simple or complex. At one extreme of the verification responsibility of the good verification agent is the simple scrutiny of the package that a reasonable image of the good exists in the delivered package by subjecting the package to a noninvasive inspection illustratively including using advanced technology like x-ray examination, radiofrequency identification tag reading, or ultrasonic imaging. The noninvasive advanced technology or x-ray equipment may also be employed to derive a higher level of scrutiny of the package by, for example, ascertaining that a given serial number exists on the good or simply identifying the serial number on the good At the other extreme of the verification responsibility of the goods verification agent is scrutiny by an expert relative to the good that the good functions as expected. The expert may either be affiliated with the goods verification agent or may be an independent third party with specific expertise in the specific good. In any case, the expert may be expected to deliver a report as to the authenticity of the good to the goods verification agent. This third-party goods verification agent has the ultimate responsibility for making the acceptance 170 or rejection 270 decision of the good relative to the agreed upon acceptance criterion, and to disseminate the information to the parties on whether the condition precedent has been met or not. Regardless of the level of verification undertaken, a verification image of the good is preferably collected during the course of the inspection and the image is transmitted to the buyer for approval. It is appreciated that the image may be a digital visual image, an X-ray, infrared, ultrasonic or other energy scan of the object or container thereof. The transmission of the agreed upon verification methodology image affords the buyer an opportunity to participate in the verification process and assure satisfaction with the good prior to receipt. Should the verification image reveal a concern, additional verification techniques can be commissioned.

If the acceptance criterion is deemed met 50 by the goods verification agent, notification is sent 40 to the escrow agent, the seller and the buyer that the condition precedent to paying the seller has been met. The escrow agent then proceeds to release the escrowed funds to the seller 70. The goods verification agent also proceeds to ship the good to the buyer 60. At this point, the transaction is completed and closed.

On the other hand, if the acceptance criterion is deemed unmet 50 by the goods verification agent, notification is sent 40 to the escrow agent, the seller and the buyer that the condition precedent to paying the seller has not been met. The escrow agent then proceeds to refund the escrowed funds to the buyer 90. The goods verification agent also proceeds to return the good to the seller 80. At this point, the transaction is completed and closed.

The system described above may be accomplished through an integrated client-server application in a distributed environment that is simultaneously accessible by the parties to the transaction in a secure manner. A person of ordinary skill in the art knows that the Internet represents such a client-server environment. If this invention is practiced on the Internet, it is understood that the parties to the transaction are communicating and transacting business through the Internet. As such, these parties are typically accessing HTML documents hosted on a server by sending an HTTP request from the client computer, with Web browser software properly installed, to the server computer through the Internet. HTTP server, firewall, data storage and processor hardware configurations are known, and server software is assumed to be properly installed on this hardware. These components are intended to be so tightly integrated as to afford the parties to the transaction an optimal state-of-the-art protection of privacy and anonymity, consistent with prevailing laws.

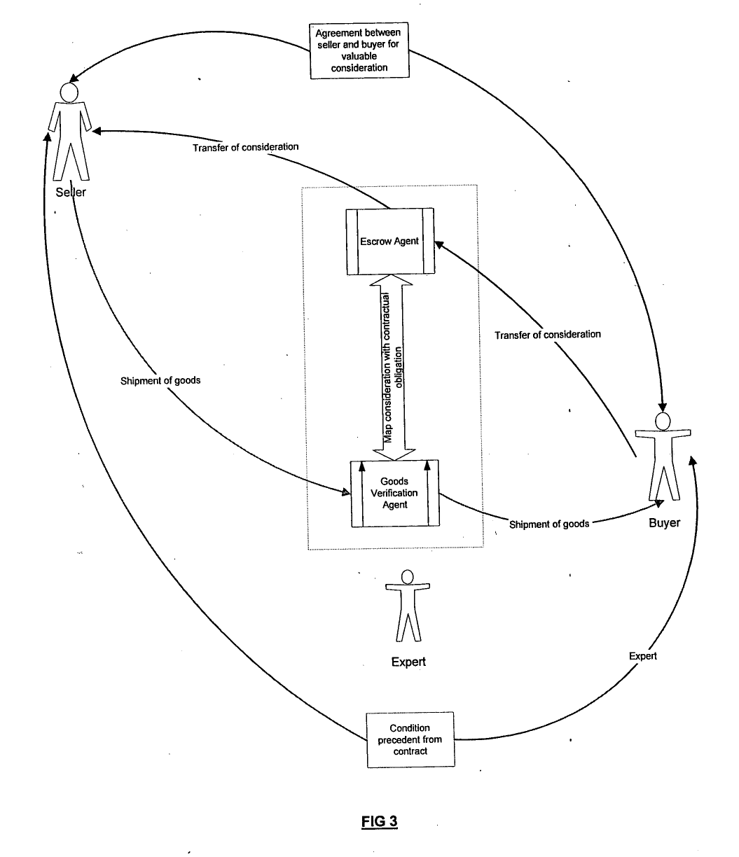

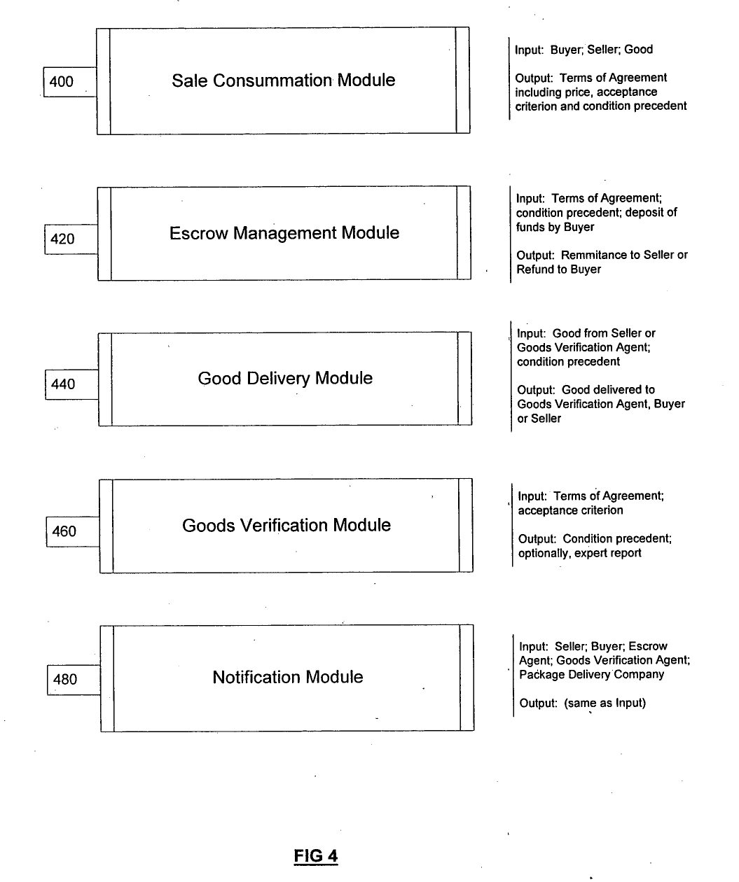

Additionally, the present invention teaches of a process for reducing fraud in electronic commercial transactions between a seller and a buyer for the purchase of goods (or services). A schematic of the disclosed process is depicted in FIG. 3 as a preferred arrangement. The various elements or modules of the disclosed process are depicted in FIG. 4 as preferred arrangements.

The sale consummation module 400 preferably allows interaction between a seller and a buyer for the offer for sale of a good by the seller and the acceptance of the offer by the buyer for terms that are mutually agreeable. As such, the input into the module includes the seller, the buyer and the good. The module allows the seller to display, announce or advertise the good that is available for sale. The module also allows the buyer to identify the good that is for sale. Furthermore, the module allows the parties to reach an agreement on the terms of the sale and purchase of the goods. These terms, generally referred to here as the terms of the agreement, include but are not limited to price, acceptance criterion, and condition precedent to payment of the seller. Preferably, this module would permit the buyer to select from a predetermined list of acceptance criteria and optionally input a specific acceptance criterion relative to the specific good. The predetermined acceptance criteria list would be compiled by seller based on experience, nature and type of good, and available noninvasive technology or manual procedure. For each such listed acceptance criterion, an associated standard cost would be provided. If the buyer opts for a specific non-listed acceptance criterion, the cost of such service would be as negotiated between the parties.

The escrow management module 420 preferably allows for the exchange of valuable consideration, including funds, between the buyer and the seller. As such, the input into this module includes the terms of the agreement and the valuable consideration or funds deposited by the buyer. The notice of an agreement between the seller and the buyer is communicated to the escrow management module from the sale consummated module. On receipt of the notice, the escrow management module proceeds to receive and escrow the funds transferred by the buyer until further instructions. These further instructions would be additional input in the form of acceptance or rejection of the condition precedent to payment of the seller. Hence, the output from this module is either a remittance of the escrowed funds to the seller or the refund of the escrowed funds to the buyer.

The good delivery module 440 preferably allows for the acceptance of goods from a seller or a goods verification agent. As such, the input into this module includes the good and delivery instructions preferably in the form of the condition precedent. Upon receipt of the good from the seller, this module awaits further instructions as to the final disposition of the good from the goods verification agent. The output from this module is delivery of the good to either of the goods verification agent, the buyer or the seller.

The goods verification module 460 preferably allows for the inspection of the good by a goods verification agent against a predetermined acceptance criterion. As such, input into this module includes the good, the term of agreement, and the acceptance criterion. Optionally, this module also affords the goods verification agent the opportunity to employ the services of an expert relative to the good in determining whether or not the condition precedent has been met. The output from this module includes a decision on acceptance or rejection of the good relative to the acceptance criterion, and optionally a report from the expert on whether or not the condition precedent has been met. The terms of the agreement include but are not limited to price, acceptance criterion, and condition precedent to payment of the seller. Preferably, this module would permit the buyer to select from a predetermined list of acceptance criteria and optionally input a specific acceptance criterion relative to the specific good.

The escrow management module 420 preferably allows for the exchange of valuable consideration, including funds, between the buyer and the seller. As such, the input into this module includes the terms of the agreement and the valuable consideration or funds deposited by the buyer. The notice of an agreement between the seller and the buyer is communicated to the escrow management module from the sale consummated module. On receipt of the notice, the escrow management module proceeds to receive and escrow the funds transferred by the buyer until further instructions. These further instructions would be additional input in the form of acceptance or rejection of the condition precedent to payment of the seller. Hence, the output from this module is either a remittance of the escrowed funds to the seller or the refund of the escrowed funds to the buyer.

The good delivery module 440 preferably allows for the acceptance of goods from a seller or a goods verification agent. As such, the input into this module includes the good and delivery instructions preferably in the form of the condition precedent. Upon receipt of the good from the seller, this module awaits further instructions as to the final disposition of the good from the goods verification agent. The output from this module is delivery of the good to either of the goods verification agent, the buyer or the seller.

The goods verification module 460 preferably allows for the inspection of the good by a goods verification agent against a predetermined acceptance criterion. As such, input into this module includes the good, the term of agreement, and the acceptance criterion. Optionally, this module also affords the goods verification agent the opportunity to employ the services of an expert relative to the good in determining whether or not the condition precedent has been met. The output from this module includes a decision on acceptance or rejection of the good relative to the acceptance criterion, and optionally a report from the expert on whether or not the condition precedent has been met.

Finally, the notification module 480 preferably manages the communication between the parties to the transaction and among the various modules of the disclosed process. Input into as well as output from this module may be received or sent from the seller, the buyer, the escrow agent, the package delivery company, and the goods verification agent through the sale consummation module, the escrow management module, the good delivery module and the goods verification module respectively. As such, this module is an essential part of this disclosure and may be implemented within an electronic commerce environment or in a traditional commercial setting.

The foregoing description is illustrative of particular embodiments of the invention, but is not meant to be a limitation upon the practice thereof. The following claims, including all equivalents thereof, are intended to define the scope of the invention.

1. A system for transaction verification comprising:
a seller of a good;
a buyer remote from said seller;
an escrow agent receiving the funds from said buyer and releasing said funds to said seller upon a condition precedent; and
a goods verification agent that verifies the good relative to a predetermined criterion to provide said condition precedent.

2. The system of claim 1 wherein said goods verification agent is remote from both said buyer and said seller.

3. The system of claim 1 wherein said goods verification agent is located at a shipment routing site.

4. The system of claim 1 wherein said goods verification agent uses a verification criterion technique selected from the group consisting of: x-ray screening, radiofrequency identification tag reading, and ultrasonic imaging.

5. The system of claim 1 wherein said criterion is serial number reading.

6. The system of claim 1 wherein the criterion is functionality of the good.

7. The system of claim 1 further comprising an expert relative to the good providing said goods verification agent with a report as to the authenticity of the good.

8. The system of claim 7 wherein the expert report is the condition precedent.

9. The system of claim 1 further comprising an image of the good collected by said goods verification agent.

10. The system of claim 9 wherein said image is of a type selected from the group consisting of: visible, X-ray, infrared, and ultrasonic.

11. A process for verifying goods in a remote buyer-seller transaction comprising the steps of:
forwarding a payment for a good from a buyer to an escrow agent;
notifying a seller that said escrow agent has received the funds from said buyer;
shipping said good to a goods verification agent from said seller;
verifying that said good satisfies a transaction criterion;
noticing said escrow agent whether said good satisfied said criterion; and
forwarding the funds to said seller upon the criterion being satisfied.

12. The process of claim 11 wherein said good not satisfying said transaction criterion is returned to said seller.

13. The process of claim 11 wherein verifying that said goods verification agent is a package delivery company.

14. The process of claim 11 wherein at least one of the steps of forwarding said payment, notifying said seller, noticing said escrow agent, and forwarding the funds occurs is an electronic communication.

15. The process of claim 11 wherein the step of verifying uses a technique of x-ray scanning.

16. The process of claim 11 wherein the step of verifying uses a technique of radiofrequency identification tag reading.

17. The process of claim 11 wherein the step of verifying uses a technique of ultrasonic imaging.

18. The process of claim 11 wherein the step of verifying uses a technique of serial number reading.

19. The process of claim 11 further comprising the step of said goods verification agent collecting an image of the good and transmitting said image to the buyer.

20. The process of claim 19 further comprising the step of receiving buyer approval prior to noticing said escrow agent.

21. The process of claim 19 wherein said image is of a type selected from the group consisting of: visible, X-ray, infrared, and ultrasonic.
